(19) United States
(12) Patent Application Publication
(10) Pub. No.: US 2012/0163689 A1
(43) Pub. Date: Jun. 28, 2012

(54) METHOD AND DEVICE FOR VISUALIZING HUMAN OR ANIMAL BRAIN SEGMENTS

(76) Inventors: Joachim BÖTTGER, Berlin (DE); Peter Vajkoczy, Berlin (DE); Peter Horn, Berlin (DE); Alexander Abbushi, Potsdam (DE); Gerd-Helge Schneider, Berlin (DE); Thomas Picht, Berlin (DE); Arno Villringer, Berlin (DE); Daniel S. Margulies, Berlin (DE)

(21) Appl. No.: 12/979,984

(22) Filed: Dec. 28, 2010

(51) Int. Cl. G06K 9/00

(52) U.S. Cl. 382/131; 382/128

(57) ABSTRACT

An embodiment of the present invention relates to a method for visualizing at least one human or animal brain segment in order to aid a stimulation or manipulation of the brain, said method comprising the steps of:
(a) predicting the localization of where a stimulation or manipulation effect is or would be, if and when initiated, and determining at least one target brain segment which is or would be stimulated or manipulated;
(b) evaluating whether at least one brain segment is functionally correlated to said at least one target brain segment;
(c) providing image data which visualize the at least one target brain segment and/or at least one of the correlated brain segments as evaluated in step (b); and
(d) displaying the image data.

The present invention relates to a method and device for visualizing human or animal brain segments in order to aid a stimulation or manipulation of the brain.

### BACKGROUND OF THE INVENTION

Functional connectivity analysis of resting-state fMRI data (fcrs-fMRI) of a human or animal brain has been shown to be a robust non-invasive method for localization of functional networks without using specific tasks, and to be promising for presurgical planning. Results of functional connectivity analysis of resting-state fMRI data is described in detail in the literature (Biswal B, Yetkin F Z, Haughton V M, Hyde J S (1995) “Functional connectivity in the motor cortex of resting human brain using echo-planar MRI”, Magn Reson Med 34:537-541; De Luca M, Beckmann C, De Stefano N, Matthews P, Smith S (2006) “fMRI resting state networks define distinct modes of long-distance interactions in the human brain”, NeuroImage 29:1359-1367; Di Martino A, Scheres A, Margulies D, Kelly A, Uddin L, Shehzad Z, Biswal B, Walters J, Castellanos F, Milham M (2008) “Functional Connectivity of Human Striatum: A Resting State fMRI Study”, Cereb. Cortex 18:2735-2747).

Many available data, such as the described resting-state fMRI data, have not yet been transferred to clinical everyday practice, nor made easily accessible to neurosurgeons. As such, visualization methods, visualization devices and stimulating or manipulating devices are needed that allow better access to the existing data.

### OBJECTIVE OF THE PRESENT INVENTION

An objective of the present invention is to provide a method of visualizing at least one human or animal brain segment in order to aid a stimulation or manipulation of the brain.

A further objective of the present invention is to provide a visualization device for visualizing at least one human or animal brain segment in order to aid a stimulation or manipulation of the brain.

A further objective of the present invention is to provide a stimulating or manipulating device allowing a stimulation or manipulation of the brain.

### BRIEF SUMMARY OF THE INVENTION

An embodiment of the invention relates to a method for visualizing at least one human or animal brain segment in order to aid a stimulation or manipulation of the brain, said method comprising the steps of:
predicting the localization of where a stimulation or manipulation effect is or would be, if and when initiated, and determining at least one target brain segment which is or would be stimulated or manipulated;
evaluating whether at least one brain segment is functionally correlated to the at least one target brain segment;
providing image data which visualize the at least one target brain segment, and/or at least one of the functionally correlated brain segments; and
displaying the image data.

Preferably, a brain segment is treated as a functionally correlated brain segment if its brain activity currently shows or has previously shown an identical or at least a similar brain activity compared to the at least one target brain segment. For instance, a brain segment may be treated as a functionally correlated brain segment if its metabolic activity over time currently shows or has previously shown an identical or at least a similar metabolic activity over time compared to the at least one target brain segment.

According to a preferred embodiment, a brain segment is treated as a functionally correlated brain segment if its oxygen and/or glucose consumption over time currently shows or has previously shown an identical or at least a similar oxygen and/or glucose consumption over time compared to the at least one target brain segment.

Further, a correlation value may be calculated for each brain segment out of a predefined plurality of brain segments, wherein each correlation value describes the correlation between the brain activity of the respective brain segment and the brain activity of the target brain segment. The image data may visualize the functional correlation values of said plurality of brain segments.

The correlated brain segments may be determined using a three dimensional brain activity data set. The brain activity data set may describe the local brain activity for each location inside the brain and may have been generated for the brain currently or potentially stimulated or manipulated.

Preferably, the three dimensional brain activity data set comprises functional magnetic resonance imaging, fMRI, data provided by a functional magnetic resonance imaging, fMRI, device. The functional magnetic resonance imaging data may be task-based fMRI data and/or resting-state fMRI data.

The method may further comprise the steps of:
generating a first image showing the brain's anatomy or a portion thereof based on an anatomy image data set,
generating a second image showing the at least one potentially stimulated or manipulated brain segment and/or at least one of the correlated brain segments, and
superimposing or overlaying the first image and the second image and displaying the superimposed or overlaid images.

The anatomy image data set may comprise or consist of tomograms generated by a MRI tomography.

The at least one potentially stimulated or manipulated target brain segment and/or at least one of the correlated brain segments is preferably visualized in real-time during change of the localization of the device's stimulation or manipulation effect.

A further embodiment of the present invention relates to a visualization device capable of visualizing the current or future stimulating or manipulating of at least one human or animal target brain segment, said device comprising:
a first unit capable of predicting the localization of the device's stimulation or manipulation effect, and determining the at least one target brain segment being currently or potentially stimulated or manipulated;
a second unit capable of evaluating whether at least one brain segment is functionally correlated to the at least one target brain segment, and
a third unit adapted to provide image data which visualize the at least one target brain segment and/or at least one of the functionally correlated brain segments; and
a display unit adapted to display the image data.

The second unit may be adapted to determine functionally correlated brain segments by using a three dimensional brain activity data set which describes the local brain activity for each location inside the brain and which has been generated for the brain currently stimulated or manipulated.

The three dimensional brain activity data set may have been generated based on data provided by a functional magnetic resonance imaging, fMRI, device.

The third unit may be adapted to generate a first image showing the at least one target brain segment and/or at least one of the functionally correlated brain segments which are identified by the second unit. The fourth unit may be adapted to generate a second image showing the brain's anatomy or a portion thereof based on an anatomy image data set, which visualizes the brain's anatomy. The fifth unit may be adapted to superimpose or overlay the first image and the second image to provide superimposed or overlaid images for visualization by the display.

The visualization device is preferably adapted to visualize the at least one target brain segment and/or at least one of the functionally correlated brain segments in real-time during change of the localization of the stimulation or manipulation effect.

The visualization device may comprise a processor and a memory, wherein the first, second, third, and fourth units may be software modules stored in the memory and being run by the processor.

A further embodiment of the present invention relates to a stimulating or manipulating device comprising a visualization device as described above and a stimulation and/or manipulation unit capable of stimulating and/or manipulating at least one human or animal brain segment.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures. Understanding that these figures depict only typical embodiments of the invention and are therefore not to be considered to be limiting of its scope, the invention will be described and explained with additional specificity and detail by the use of the accompanying drawings in which

FIG. 1 shows an exemplary embodiment of a visualization device according to the present invention,

FIG. 2 shows an exemplary embodiment of a stimulating or manipulating device according to the present invention, and

FIG. 3 an example of two superimposed images shown by a display of the visualization device according to FIG. 1.

### DETAILED DESCRIPTION OF THE PREFERRED EMBODIMENTS

The preferred embodiments of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

The outcome of neurosurgical interventions benefits from knowledge about the location of specific functional areas in the brain. For example, pre-surgical identification of circumscribed functional regions in relation to a tumor can be a substantial advantage in surgical planning. The gold-standard method for such functional localization, intraoperative electrical stimulation mapping, is invasive and limited to the localization of a few main cortical functional areas accessible during intracranial interventions. In contrast, a non-invasive imaging technique, “task-based” functional magnetic resonance imaging (fMRI), is capable of non-invasively showing the location of a diverse array of functional regions by using task paradigms to identify the implicated areas (Vlieger E, Majoie C B, Leenstra S, den Heeten G J (2004) “Functional magnetic resonance imaging for neurosurgical planning in neurooncology”, European Radiology 14:1143-1153).

Although seemingly of great promise for clinical application, task-based fMRI has seen limited integration into the technical repertoire of neurosurgical planning due to several practical constraints: special experimental setup, relatively long measuring time, high demand on patients for cooperation, and the substantial training and expertise required for processing the data. Furthermore, localization of each functional area using task-based fMRI requires a specialized task.

A novel technique in functional neuroimaging termed “resting-state fMRI”, in contrast to traditional task-based fMRI, measures changes in BOLD (Blood-oxygen-level dependence) signal without the patient being subjected to any task (i.e. spontaneous fluctuations). A formidable body of research in brain and neurological science over the past years has demonstrated the feasibility of using spontaneous fluctuations in fMRI data to map functional systems.

Various functional areas and networks throughout the entire brain can be mapped using a single resting-state fMRI scan: The basic underlying observation is that even in a task-independent state, the brain shows spontaneous fluctuations in fMRI activity which are far from random. The correlation between spontaneous fluctuations across different regions reflects areas that are functionally relevant to each other, and can be described as “functionally connected” (Fox M D, Raichle M E (2007) Spontaneous fluctuations in brain activity observed with functional magnetic resonance imaging. Nat Rev Neurosci 8:700-711). The resulting methodology is termed “functional connectivity analysis of resting-state fMRI” (fcrs-fMRI). The classic method for the analysis of functional connectivity may be based on taking the signal from a region-of-interest (ROI) and assessing its correlation with all other regions of the brain (termed: “seed-based” functional connectivity).

Exemplary embodiments of the invention as described hereinafter relate to a novel interactive visualization tool allowing the exploration of task-based and/or resting-state fMRI data (and/or other data) for neurosurgical use.

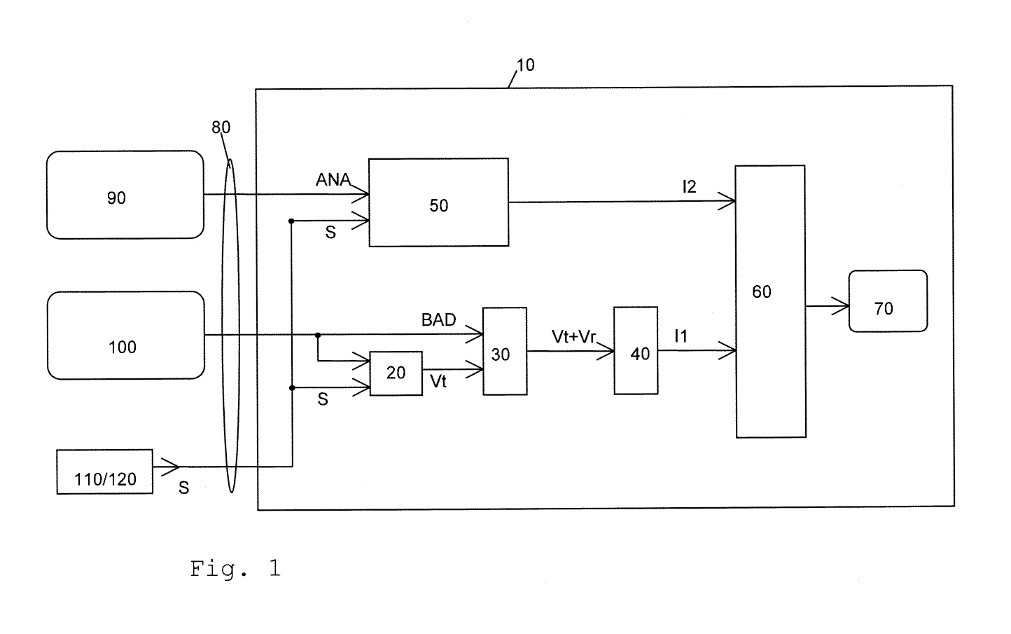

FIG. 1 shows an exemplary embodiment of a visualization device 10 according to the present invention. The visualization device 10 comprises a first unit 20, second unit 30, a third unit 40, a fourth unit 50, a fifth unit 60, and a display unit 70.

The visualization device 10 further comprises an interface 80 which allows to enter anatomy data ANA of an anatomy data set 90, brain activity data BAD of a three dimensional brain activity data set 100, and a target signal S.

The three dimensional brain activity data set 100 describes the local brain activity for each location inside the brain and is currently or has previously been generated. The three dimensional brain activity data set 100 is preferably generated based on data provided by a functional magnetic resonance imaging, fMRI, device. The three dimensional brain activity data are preferably resting-state functional MRI data.

The local brain activity data may indicate the metabolic activity of the brain segments. The metabolic activity of the brain segments may be determined by measuring the oxygen consumption and/or the blood oxygen saturation of the brain segments over time.

The anatomy data ANA of the anatomy data set 90 may comprise or consist of tomograms generated by MRI tomography.

The target signal S may be generated by an external stimulation and/or manipulation unit 110, or by an external simulation unit 120 which simulates the functionality of an external stimulation and/or manipulation unit.

The visualization device 10 may operate as follows:

First, a target signal S is generated which defines three dimensional coordinates of a given location. The given location corresponds to a measured or estimated location of a stimulation and/or manipulation effect which is currently provided by the stimulation and/or manipulation unit 110 or which could be provided by the stimulation and/or manipulation unit 110 at a later stage.

The target signal S is entered via the interface 80 and reaches the first unit 20. The first unit 20 may be a prediction unit which predicts the localization of the device's stimulation or manipulation effect in the human or animal brain, and determines at least one target brain segment which is or would be stimulated or manipulated if/when a stimulation or manipulation is or would be carried out at said given location defined by the target signal S. Said at least one brain segment is referred to as target volumetric element Vt hereinafter. The first unit 20 provides the target volumetric element Vt to the second unit 30.

The second unit 30 may be a correlation unit which analyzes the brain activity data BAD of the three dimensional brain activity data set 100 with reference to the target volumetric element Vt. During this analysis, the second unit 30 evaluates whether brain segments are functionally correlated to the target brain segment, and determines all or at least a few of the functionally correlated brain segments that show identical or at least similar brain activity compared to the target volumetric element Vt. The related brain segments are referred to as correlated or related volumetric elements Vr hereinafter.

The second unit 30 provides the target volumetric element Vt and the correlated volumetric elements Vr to the third unit 40.

The third unit 40 may be a first visualization unit which generates a first image I1 showing the target and the correlated volumetric elements Vt and Vr.

The fourth unit 50 may be a second visualization unit which analyzes the target signal S and the anatomy data ANA of the anatomy data set 90. As a result, the fourth unit 50 generates a second image I2 showing the brain's anatomy or a portion thereof, including the target volumetric element Vt, based on the anatomy image data set 90.

The first image I1 and the second image I2 are sent to the fifth unit 60 which is preferably formed by a superimposing unit.

The fifth unit 60 superimposes or overlays the first image I1 and the second image I2, and provides a superimposed image I1+I2 for visualization by the display 70.

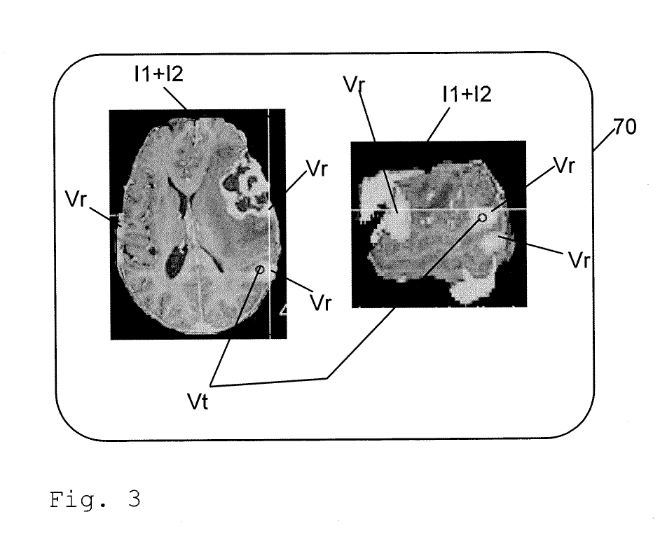

An example of two superimposed images I1+I2 is shown in FIG. 3. The anatomy of the brain is shown in two orthogonal cross sections. The targeted volumetric element Vt and the correlated volumetric elements Vr are indicated in an exemplary fashion.

The first, second, third and fourth units may be realized by software modules stored in a memory and being run by a processor.

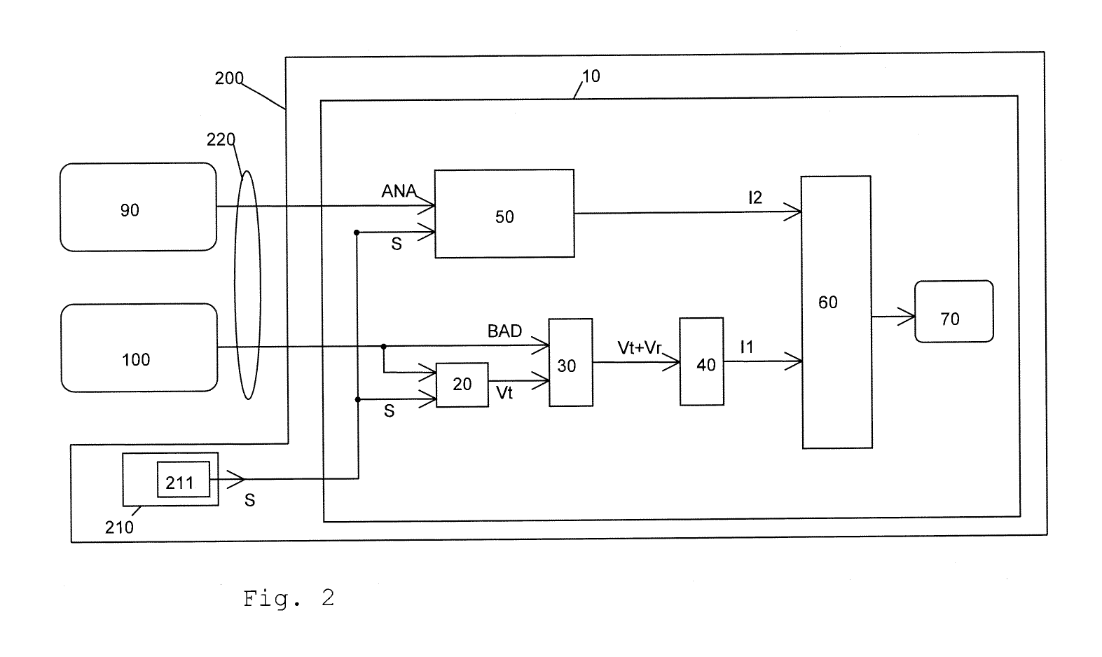

FIG. 2 shows an exemplary embodiment of a stimulating or manipulating device 200 according to the present invention. The stimulating or manipulating device 200 comprises a visualization device 10 comprising a first unit 20, a second unit 30, a third unit 40, a fourth unit 50, a fifth unit 60, and a display unit 70. The visualization device 10 may be similar or identical to the visualization device 10 as described in detail above with reference to FIG. 1.

The stimulating or manipulating device 200 further comprises a stimulation or manipulation unit 210 capable of stimulating or manipulating at least one human or animal brain segment. For stimulation and/or manipulation, the stimulation or manipulation unit 210 preferably generates a focused electrical or magnetical field inside the brain. To this end, the stimulation or manipulation unit 210 may comprise at least one magnetic coil, which may be placed outside the brain, to generate a magnetic field inside the brain. Additionally or alternatively, the stimulation or manipulation unit 210 may comprise at least one electrode, which may be placed inside or outside the brain, to generate an electric field inside the brain.

The stimulation or manipulation unit 210 further comprises a control unit 211 which allows a user to change the location of the stimulation or manipulation effect. The control unit 211 preferably generates a target signal S defining three dimensional coordinates of the location where the stimulation and/or manipulation effect is currently concentrated.

Moreover, the stimulating or manipulating device 200 may comprise an interface 220 for entering anatomy data ANA of an anatomy data set 90, and brain activity data BAD of a three dimensional brain activity data set 100.

The stimulating or manipulating device 200 may operate as follows:

During stimulation or manipulation, the visualization device 10 evaluates the target signal S of the stimulation or manipulation unit 210, and predicts the current localization of the device's stimulation or manipulation effect in the human or animal brain. Then, it generates a superimposed image I1+I2 for visualization by its display 70. The superimposed image I1+I2 shows the anatomy of the brain, the current targeted brain segment, and correlated brain segments that have identical or at least similar brain activity compared to the currently targeted brain segment. An example of two superimposed images I1 and I2 as displayed by display 70 is depicted in FIG. 3.

The embodiments as described above with reference to FIGS. 1-3 may be implemented based on LIPSIA, a freely available MRI data processing suite. LIPSIA already implements certain precomputation steps, as well as the masking-out of voxels (volumetric elements) in order to optimize correlation computation. In order to implement real-time interaction a further restriction of correlation computation may be applied to only three visible slices present in the standard LIPSIA triplanar visualization. The combination of these approaches yields re-draw rates of approximately 0.1 seconds during a shift of the seed region-of-interest, which is sufficiently fast for fluent interaction.

AFNI recently introduced interactive functional connectivity visualization as part of its standard distribution. Using highly optimized computational methods, “InstaCorr” (afni.nimh.nih.gov/pub/dist/doc/misc/instacorr.pdf) achieves comparable speed of calculation while conducting correlation across the whole brain.

The embodiments as described above with reference to FIGS. 1-3 may integrate the process of seed selection and the visualization of correlation results. Instead of picking a seed point according to anatomical data, and then calculating the result, both may be done seemingly simultaneously.

Correlation of time-series from volumetric data using a seed region-of-interest (ideal time-series) is computationally a time consuming problem for real-time applications. For every voxel in the volume (approximately 200,000), the respective time-series (with approximately 200 time points) have to be correlated with the ideal time-series, typically requiring several hundreds of millions of operations. The following options, which reduce the number of real-time computations in various ways, can be employed to make display feasible at interactive frame rates (typically less than 0.1 seconds between successive frames):

### 1. Reduce the Resolution:

After interacting in real-time with lowered resolution, which is less computationally demanding due to fewer voxels, the chosen seed regions-of-interest can be reanalyzed at full-resolution. However, this option is the least advantageous due to loss of anatomical specificity.

2. Restrict the Tissue Type for which Correlation has to be Computed:

A mask of voxels located within the brain reduces the computational demands tremendously. Excluding “non-grey matter” voxels from analysis may further accelerate the computation. For example, one could exclude white matter and ventricles using tissue segmentation, and limit data analysis only to grey matter, or one could only analyze a specific region-of-interest.

### 3. Restrict the Computation to the Visible Areas:

Rather than restrict tissue types, it is possible to only compute the information necessary for the current display (in our case, the three two-dimensional orthogonal slices in a standard tri-planar view).

### 4. Precomputation:

This approach does not reduce the number of required computations, but rather conducts them in advance. Correlation, as implemented in functional connectivity analysis, consists of two terms, one of which is independent from the ideal time-series. This term can be calculated and stored before interaction. With sufficient memory, it is also possible to completely precompute the correlation between every pair of voxels in the measured volume. Such a correlation matrix takes typically an hour to compute, and several Gigabytes of RAM.

The same precomputation could also be conducted for smaller regions of interest, reducing the required time and memory drastically.

For providing the images as described above with reference to FIGS. 1-3, MR scanner systems may be used. The following parameters may be established to optimize the measurements results: On a GE 3-Tesla scanner equipped with an 8-channel head coil, fMRI may be acquired using a standard echo-planar imaging sequence (repetition time=2500 ms, echo time=30, flip angle=83°, voxel dimensions=1.71873×1.71873×4 mm). High resolution “anatomical” images may be obtained using a T1-weighted pulse sequence (MPRAGE, TR=7224 s; TE=3.1 ms; TI=900 ms; flip angle=8; 154 slices, FOV=240 mm). On a Siemens 3-Tesla Tim Trio scanner equipped with a 12-channel head coil, fMRI may be acquired using a standard echo-planar imaging sequence (repetition time=2300 ms, echo time=30, flip angle=90°, voxel dimensions=3×3×4 mm). Anatomical scans may be obtained using a T1 weighted pulse sequence (MPRAGE, TR=1900/2300 ms; TE=2.52/2.98 ms; TI=900 ms; flip angle=9; 192/176 slices, FOV=256 mm).

The data may be preprocessed using a combination of Free-surfer (http://surfer.nmr.mgh.harvard.edu/), AFNI (http://afni.nimh.nih.gov/), and FSL (http://www.fmrib.ox.ac.uk/fsl/), all freely available standard data analysis packages. Preprocessing for the functional data, which has been described previously may include: slice-timing correction for interleaved slice acquisition and motion correction in six degrees-of-freedom (AFNI). The six motion components and a “global” signal (extracted from the average signal over the entire brain) may be used as covariates in a general linear model. The residual data may then be bandpass filtered between 0.02-0.08 Hz and spatially smoothed using a 6 mm full-width half-maximum Gaussian kernel (AFNI).

Typically, the functional measurements consist of isotropic samplings on a voxel grid with 3-4 mm voxel size, using a standard BOLD-sensitive EPI sequence for rapid volumetric coverage of the whole brain (typ. 17×14×10 cm field of view). The measurements are sensitive to changes in blood oxygenation, and typically a complete volume is acquired every 1-4 seconds. Recent advances have made resolutions in the sub-millimeter range and much shorter acquisition times with multiple volumes per second possible. Further improvements can be expected. It is also possible to increase spatial and temporal resolution by restricting the sampling to a sub-region of the brain. Therefore, achievable resolution ranges from a few millimeters down to 0.1 mm and even lower, depending on sampling and other parameters. Other modalities like Positron Emission Tomography (PET), Magnetoencephalography (MEG), and Electroencephalography (EEG) may result in similar functional datasets of localized changes in brain function over time. While using single voxels as seed-regions of interest is possible, typically collections of neighboring voxels are taken into account in order to increase the signal to noise ratio, e.g. spherical regions with a 5 mm radius, or a neighborhood of voxels with similar radius along the cortical gray matter after a segmentation of the different tissue types.

The anatomical volume may be skull stripped using the standard Freesurfer processing path. A single functional volume may then be registered to the skull-stripped anatomical volume using FSL's linear registration tool, and the resulting transformation matrix may be applied to the entire functional data set.

To detect the sensorimotor network, a mouse cursor, which defines the location of the stimulation or manipulation effect and thus decides about the targeted voxel, may be placed on the lateral motor cortex, anterior to the central sulcus, and the region of interest shifted until a symmetrical network appeared across pre- and post-central gyri, as well as supplementary motor area. For the language network, the mouse cursor may be placed in the left inferior frontal gyrus, adjacent to the precentral sulcus, which corresponds to Broca's area (anterior operculum). By shifting the location slightly, it is possible to detect functional connectivity in the sagittal plane to the posterior portion of the superior temporal gyrus (Wernicke's area) and adjacent inferior parietal cortex. For the dorsal-attention network, the cursor may be placed in the superior frontal gyrus and shifted until functional connectivity in the axial slice is visible bilaterally in both frontal regions and the intraparietal sulcus. The default-mode network may be identified with the cursor placed in the posterior cingulate. Functional connectivity from this region is visible in the medial prefrontal cortex along the sagittal plane, as well as bilateral inferior parietal cortex visible in the coronal plane.

Using the procedure described above, an experienced fcrs-fMRI researcher needed less than two minutes to identify the described four networks per case, less than 30 seconds on average per network.

Summarizing, the embodiments of the present invention as described above with respect to FIGS. 1-3, enable the analysis and visualization of functional connectivity using “resting-state fMRI” data at a speed that allows for real-time exploration of regions of interest.

### REFERENCE SIGNS

10 visualization device
20 first unit
30 second unit
40 third unit
50 fourth unit
60 fifth unit
70 display unit
80 interface
90 anatomy data set
100 brain activity data set
110 external stimulation and/or manipulation unit
120 simulation unit
200 stimulating or manipulating device
210 stimulation or manipulation unit
211 control unit
220 interface
ANA anatomy data
BAD brain activity data
I1 first image
I2 second image
S target signal
Vr related volumetric element
Vt target volumetric element

1. A method for visualizing at least one human or animal brain segment in order to aid a stimulation or manipulation of the brain, said method comprising the steps of:
(a) predicting the localization of where a stimulation or manipulation effect is or would be, if and when initiated, and determining at least one target brain segment which is or would be stimulated or manipulated;
(b) evaluating whether at least one brain segment is functionally correlated to said at least one target brain segment;
(c) providing image data which visualize the at least one target brain segment and/or at least one of the correlated brain segments as evaluated in step (b); and
(d) displaying the image data.

2. Method of claim 1 wherein
a brain segment is treated as a functionally correlated brain segment if its brain activity currently shows or has previously shown an identical or at least a similar brain activity compared to the at least one target brain segment.

3. Method of claim 2
wherein a brain segment is treated as a functionally correlated brain segment if its metabolic activity over time currently shows or has previously shown an identical or at least a similar metabolic activity over time compared to the at least one target brain segment.

4. Method of claim 3
wherein a brain segment is treated as a functionally correlated brain segment if its oxygen and/or glucose consumption over time currently shows or has previously shown an identical or at least a similar oxygen and/or glucose consumption over time compared to the at least one target brain segment.

5. Method of claim 1,
wherein a correlation value is calculated for each brain segment out of a predefined plurality of brain segments, each correlation value describing the correlation between the brain activity of the respective brain segment and the brain activity of the target brain segment, and
wherein said image data visualize the degree of functional correlation of said plurality of brain segments with respect to the target brain segment.

6. The method of claim 1 wherein the functional correlation is determined using a three dimensional brain activity data set, which describes the local brain activity for each location inside the brain.

7. The method according to claim 6 wherein said three dimensional brain activity data set is generated based on data provided by a functional magnetic resonance imaging, fMRI, device.

8. The method according to claim 7 further comprising the steps of:
generating a first image showing the brain's anatomy or a portion thereof based on an anatomy image data set,
generating a second image showing the at least one target brain segment and/or at least one of the functionally correlated brain segments, and
superimposing or overlaying the first image and the second image and displaying the superimposed or overlaid images.

9. The method according to claim 8 wherein said anatomy image data set comprises or consists of tomograms generated by a MRI tomography.

10. The method according to claim 1 wherein the at least one target brain segment and/or at least one of the functionally correlated brain segments is visualized in real-time during change of the localization of the device's stimulation or manipulation effect.

11. A visualization device capable of visualizing the current or potential stimulating or manipulating of at least one human or animal target brain segment, said device comprising:
a first unit capable of predicting the localization of the device's stimulation or manipulation effect, and determining the at least one target brain segment being currently or potentially stimulated or manipulated;
a second unit capable of evaluating whether at least one brain segment is functionally correlated to the at least one target brain segment, and
a third unit adapted to provide image data which visualize the at least one target brain segment and/or at least one of the functionally correlated brain segments; and
a display unit adapted to display the image data.

12. The visualization device according to claim 11 wherein the second unit is adapted to evaluate the functional correlation based on a three dimensional brain activity data set which describes the local brain activity for each location inside the brain.

13. The visualization device according to claim 12 wherein said three dimensional brain activity data set is generated based on data provided by a functional magnetic resonance imaging, fMRI, device.

14. The visualization device according to claim 13
wherein said third unit is adapted to generate a first image showing the at least one target brain segment and/or at least one of the functionally correlated brain segments which are identified by the second unit,
wherein a fourth unit is adapted to generate a second image showing the brain's anatomy or a portion thereof based on an anatomy image data set, which visualizes the brain's anatomy,
and
wherein a fifth unit is adapted to superimpose or overlay the first image and the second image to provide the superimposed or overlaid images for visualization by the display.

15. The visualization device according to claim 14 wherein said anatomy image data set comprises or consists of tomograms generated by a MRI tomography.

16. The visualization device according to claim 11 wherein the device is adapted to visualize the at least one target brain segment and/or at least one of the functionally correlated brain segments in real-time during change of the localization of the stimulation or manipulation effect.

17. The visualization device according to claim 11 comprising a processor and a memory.

18. The visualization device according to claim 17 wherein said first, second, third and fourth units are software modules stored in said memory and being run by said processor.

19. A stimulating or manipulating device comprising a visualization device according to claim 11 and a stimulation and/or manipulation unit capable of stimulating and/or manipulating at least one human or animal brain segment.
